(19) United States
(12) Patent Application Publication
(10) Pub. No.: US 2007/0054743 A1
(43) Pub. Date: Mar. 8, 2007

(54) Transmission joint, in particular for transmitting drive between non-aligned shafts

(76) Inventor: Peter Pleyer, Bad Essen (DE)

Correspondence Address: RATNERPRESTIA, P O BOX 980, VALLEY FORGE, PA, 19482-0980, US

(21) Appl. No.: 10/572,988

(22) PCT Filed: Oct. 8, 2003
(86) PCT No.: PCT/IT03/00604

§ 371 Date: Mar. 23, 2006

(51) Int. Cl. F16D 3/00

(52) U.S. Cl. 464/106

(57) ABSTRACT

A transmission joint for transmitting drive between a first shaft and a second shaft includes a first joint element and a second joint element which can be mutually coupled for the transmission of the drive between the shafts, each element being rotatable about a respective first or second axis of rotation. The first joint element includes an approximately spheroidal body formed by a plurality of adjacent segment-like portions having curved external profile surfaces and defining, transverse the first axis, cross-sections of the body with polygonal outlines. The spheroidal body can engage a blind axial cavity of the second joint element having a cross-section, transverse the second axis with a polygonal outline corresponding to the profile of the body and of dimensions such that the first joint element is housed in the second joint element with mutual torsional coupling and a capability for relative inclination of the axes of the joint elements for the transmission of drive between the shafts with non-aligned axes. The joint elements limit the relative angular inclination of the axes of rotation of the joint elements, in order consequently to permit the correct transmission of drive between inclined shafts, up to a preselected maximum angular inclination.

### TECHNICAL FIELD

The present invention relates to a transmission joint, and in particular, a transmission joint for transmitting drive between a first shaft and a second shaft, and includes a first and second joint element which can be mutually coupled for the transmission of the drive between shafts.

Transmission joints of the type indicated are typically used for transmitting drive in particular between non-aligned shafts in applications which require mainly reliability and structural simplicity, such as applications relating to the drive transmissions that are provided on agricultural machines in general.

### TECHNOLOGICAL BACKGROUND

An example of this type of joint is known from the abstract of published Japanese patent application No. 03079185A. In the joint described therein, the hexagonal profile of the members of the joint that are in mutual engagement ensures torsional coupling and, because of the approximately spheroidal shape of one of the members of the joint and the corresponding housing cavity in the other member of the joint, which cavity extends axially with a cross-section having a hexagonal outline, the drive can also be transmitted between shafts with inclined axes.

One of the limitations of the known solutions lies in the fact that, beyond a particular degree of relative inclination between the axes of the joint, because of the geometry of the coupling between the members that are in mutual contact, the transmission of the drive gradually becomes uneven and may lead to the risk of locking of the joint for inclinations which exceed the limits permitted by the geometry provided for the coupling.

### DESCRIPTION OF THE INVENTION

A main object of the present invention is to provide a transmission joint of the above-mentioned type which ensures correct transmission of the drive within a preselected range of possible angular inclinations between the axes of the joint and which prevents these limits being exceeded, thus preventing locking of the joint.

Another object is to provide a joint which enables the drive to be transmitted between the driven and driving shafts in the presence of relative tensile or compression stresses between the shafts, in particular with stresses which tend to pull the elements of the joint apart.

Yet another object is that of obtaining a joint which is particularly compact as a whole and which has improved structural simplicity and, in particular, which can be produced with a limited number of parts for quick and easy assembly and dismantling of the joint.

These objects, and yet others which will become clear from the following description, are achieved by the present invention of a transmission joint for transmitting drive between a first shaft and a second shaft, including a first joint element and a second joint element which can be mutually coupled for the transmission of the drive between the shafts, each joint element being rotatable about a respective first or second axis of rotation. The first joint element includes an approximately spheroidal body formed by a plurality of adjacent segment-like portions having curved external profile surfaces and defining, transverse the first axis, cross-sections of the body with polygonal outlines. The spheroidal body being able to engage a blind axial cavity of the second joint element having a cross-section, transverse the second axis, with a polygonal outline corresponding to the profile of the body and of dimensions such that the first joint element is housed in the second joint element with mutual torsional coupling and a capability for relative inclination of the axes of the joint elements for the transmission of drive between the shafts with non-aligned axes. The transmission joint further includes, on the joint elements, means for limiting the relative angular inclination of the axes of rotation of the joint elements, to permit the correct transmission of drive between inclined shafts, up to a preselected maximum angular inclination. The first and second joint elements include a first portion and a second portion which are shaped as spherical sectors forming parts of a common spherical profile of preselected radius, a shell element with a spherical internal surface being provided for containing the spherical-sector-shaped portions and restraining them with relative coupling of a ball-and-socket type, with a common centre of rotation between the shell and the spherical sectors.

### BRIEF DESCRIPTION OF THE DRAWINGS

Further characteristics and advantages of the invention will become clearer from the following detailed description of a preferred embodiment thereof which is described by way of non-limiting example with reference to the appended drawings, in which:

FIG. 1 is an exploded, perspective view of a transmission joint formed in accordance with the present invention,

FIG. 2 is a perspective view of the joint of FIG. 1 in the assembled condition,

FIG. 3 is a partial axial section through the joint of the invention in a first operative condition, with axes of rotation of the joint elements in mutual alignment, and

FIG. 4 is a partial axial section through the joint of the previous drawings in a second operative condition, with axes of rotation of the joint elements inclined to one another at the maximum permitted angular inclination.

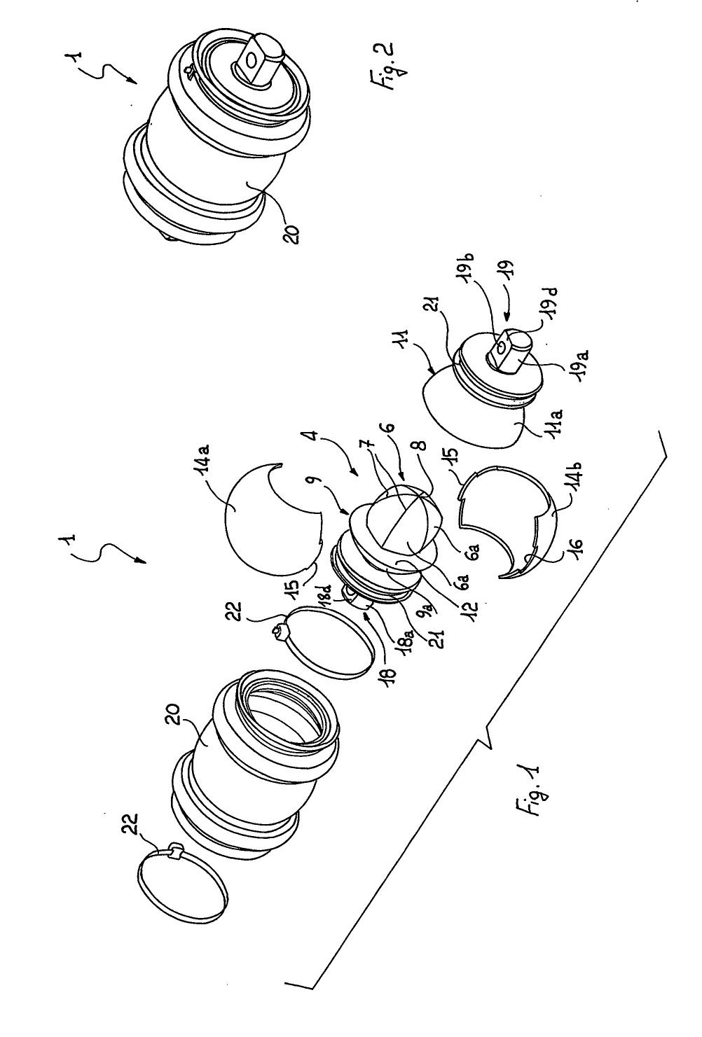

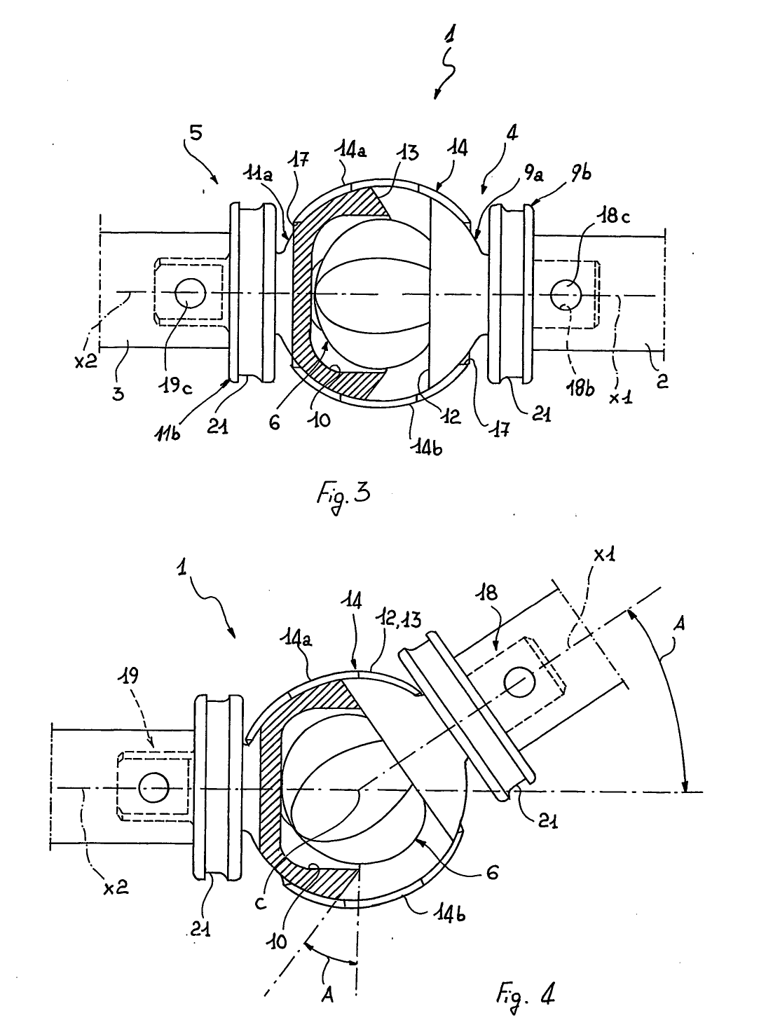

### PREFERRED EMBODIMENT OF THE INVENTION

With reference to the drawings mentioned, a transmission joint formed in accordance with the present invention and generally indicated 1 is arranged for transmitting drive between a pair of shafts 2, 3 which are shown only partially in the drawings.

The joint 1 comprises a first joint element and a second joint element which are indicated 4 and 5, respectively, and which can be fixed for rotation with the shafts 2 and 3, respectively, about corresponding axes of rotation X1 and X2.

The first joint element 4 comprises an approximately spheroidal body 6 formed by a plurality of adjacent segment-like portions 6a which are elongate in the direction of the axis X1. The outer surface of each segment-like portion 6a has a curved profile, in particular, of spherical shape and is delimited by opposed edges 7. At the free axial end of the body 6, the edges 7 converge at a common vertex 8 and, at the opposite axial end, the body is extended by a portion 9 of the first joint element which is shaped as a spherical sector 9a and the function of which will become clear from the following description. The spheroidal body 6 has cross-sections (perpendicular to the axis X1) with polygonal profiles and in particular with regular hexagonal geometry.

The second joint element 5 comprises a blind axial cavity 10 constituting a seat for housing the body 6. The cavity 10 extends coaxially with the axis X2 with a substantially uniform cross-section (perpendicular to the axis X2) and having a corresponding regular hexagonal profile. This cross-section is selected so as to have a dimension slightly greater than that of the maximum diametrical cross-section of the spheroidal body 6 so that the body is housed in the cavity 10 with a small radial clearance between the above-mentioned portions; this is to ensure mutual torsional coupling between the body 6 and the corresponding cavity 10 and at the same time to permit a relative inclination between the axes X1 and X2 (FIG. 4) so as to ensure the transmission of drive between one of the joint elements 4, 5 and the other, even with shafts 2, 3 having axes X1, X2 that are inclined to one another.

The blind cavity 10 is formed in a respective portion 11 of the second joint element 5 which is also shaped as a spherical sector 11a.

The spherical regions of the sectors 9a, 11a belong to the same spherical profile of preselected and common radius and may be considered as parts of the same spherical volume, separated by a substantially spherical segment-shaped interruption region.

A shoulder surface 12 is defined on the portion 9 of the first joint element between the said portion and the body 6 (at least partially constituting the base of the spherical sector 9a) and has a flat annular configuration, extending perpendicularly relative to the axis X1. A tapered surface 13 is correspondingly defined on the portion 11 of the second joint element 5. The surface 13 extends around the blind cavity 10 so as to adjoin the spherical sector 11a and has generatrices of the tapered profile which are inclined to the perpendicular to the axis X2 at a preselected angle, indicated A in FIG. 4.

The angle A corresponds to the maximum permitted angle of inclination between the axes X1 and X2. In fact, as can clearly be seen from FIG. 4, at this maximum inclination, the surfaces 12 and 13 are brought into contact with one another. More particularly, these surfaces are brought into mutual abutment, tangentially relative to one another, with relative rolling of one surface on the other during the rotation of the joint elements about their respective axes. The surfaces 12, 13 thus constitute means for limiting the relative angular inclination between the axes X1, X2 of the joint and the maximum permitted inclination (angle A) is selected so as to ensure correct transmission of the drive between the members that are in mutual contact for values below the preselected threshold and to prevent this threshold being exceeded, thus preventing the possible risk of locking of the joint. Preferred values of the maximum permitted inclination are advantageously selected within a range of values of between 250 and 350. The provision of the surfaces 12 and 13 thus offers mutual support between the elements of the joint at its maximum aperture, irrespective of the relative spatial orientation of the axes X1, X2, thus ensuring the functional capacity of the joint for any relative positioning of the shafts 2 and 3 imposed by the particular application.

It should also be pointed out that the spherical sectors 9a, 11a are centred on a common centre of the spherical volume of which they form parts; this centre coincides with the virtual centre of rotation of the joint indicated C in FIG. 4.

The joint 1 is also provided with a shell-shaped element 14 for containing the portions 9, 11 of the joint with a small radial clearance so as to restrain them with relative coupling of the ball-and-socket type, with a common centre of rotation between the shell 14 and the spherical sectors 9a, 11a.

The shell 14 is preferably formed as two half-shells 14a, 14b of predominantly hemispherical shape which can be connected to one another, for example, by a releasable mechanical coupling. Advantageously, this coupling may have lips 15 for engaging respective recesses 16, for example, formed in opposed pairs on one and on the other of the half-shells, for a restrained mutual connection.

It should be noted that the restraining effect of the shell 14 on the joint elements 4, 5 with relative coupling of the ball-and-socket type is such as to permit the transmission of drive between the shafts 2 and 3 even in the presence of stresses exerted between the shafts and, in particular, in the presence of axial tension or compression stresses.

The shell 14 also has respective openings 17 formed in the region of the axes X1, X2 of rotation of the joint elements to permit the insertion of respective axial ends 18, 19 of these elements. Naturally, the openings 17 are of an extent such as to permit the relative inclination between the joint elements 4, 5, up to the maximum permitted inclination (angle A).

The ends 18, 19 have respective attachment elements 18a, 19a for connection to the shafts 2, 3; the attachment elements 18a, 19a have a cylindrical shank-like shape with respective through-holes 18b, 19b. The shanks are arranged for engaging corresponding seats (blind cavities with transverse through-holes) formed at the axial ends of the shafts 2, 3 for the clamping of the shafts onto the joint by means of respective spring cotters 18c, 19c driven into the corresponding holes 18b, 19b. Each shank 18a, 19a also has a flat surface 18d, 19d for a possible different connection of the shafts to the joint, although the above-described embodiment of the attachment represents a preferred selection.

Each portion 9, 11 may also comprise further shoulders 9b, 11b between which a tubular joint cover 20 with a protective function is mounted for containing and covering the shell 14 and the mutually coupled joint elements housed therein.

The shoulders 9b, 11b advantageously have annular grooves 21 for facilitating the clamping of the axial ends of the protective joint cover 20 onto the respective shoulder by means of clamps 22 or similar clamping means.

Finally, it is pointed out that the body 6 and the corresponding spherical sector-shaped portion 9 of the first joint element 4 may be produced as a unitary part and that the cavity 10 may be formed integrally in the second joint portion 11. As a result, the joint 1 is therefore manufactured with a limited number of parts and, in particular, with four main parts, that is, the joint portions 9 and 11 as well as the two half-shells of the shell 14.

The invention thus achieves the objects proposed, affording many advantages over known solutions.

An advantage which should be pointed out in particular is that, with the joint of the invention, abutment is brought about between the joint elements at the maximum aperture and prevents locking of the joint.

A second advantage is that the joint according to the invention is self-supporting by virtue of the provision of the shell for housing the joint elements with coupling of the ball-and-socket type, enabling axial tensile or compressions stresses also to be transmitted in the same way as a conventional universal joint.

A further advantage lies in the structural simplicity and the ease and rapidity of assembly/dismantling of the joint which are achieved by the provision of a limited number of parts, which are also of small dimensions, for an advantageous overall compactness of the joint.

1. A transmission joint for transmitting drive between a first shaft and a second shaft, comprising a first joint element and a second joint element which can be mutually coupled for the transmission of the drive between the shafts, each joint element being rotatable about a respective first or second axis of rotation, the first joint element including an approximately spheroidal body formed by a plurality of adjacent segment-like portions having curved external profile surfaces and defining, transverse the first, cross-sections of the body with polygonal outlines, the spheroidal body being able to engage a blind axial cavity of the second joint element having a cross-section, transverse the second axis, with a polygonal outline corresponding to the profile of the body and of dimensions such that the first joint element is housed in the second joint element with mutual torsional coupling and a capability for relative inclination of the axes of the joint elements for the transmission of drive between the shafts with non-aligned axes, the transmission joint further including, on the joint elements, means for limiting the relative angular inclination of the axes of rotation of the joint elements, to permit the correct transmission of drive between inclined shafts, up to a preselected maximum angular inclinations, the first and second joint elements include a first portion and a second portion which are shaped as spherical sectors forming parts of a common spherical profile of preselected radius, a shell element with a spherical internal surface being provided for containing the spherical-sector-shaped portions and restraining them with relative coupling of a ball-and-socket type, with a common centre of rotation between the shell and the spherical sectors.

2. A joint according to claim 1 in which the limiting means comprise at least a first surface and a second surface defined on the first and second joint elements, respectively, the first and second surfaces being capable of contacting and bearing against one another at the preselected maximum inclination between the axes of the joint elements.

3. A joint according to claim 1 in which the first and second surfaces are selected with profiles such that, at the maximum inclination between the shafts, they are in mutual contact, tangentially relative to one another, during the transmission of drive between the elements of the joint.

4. A joint according to claim 3 in which one of the surfaces has a flat configuration extending transverse the axis of rotation of the corresponding joint element and the other of the surfaces has a tapered configuration with generatrices that are inclined to a plane perpendicular to the axis of rotation of the corresponding joint element at an angle equal to the selected maximum inclination between the axes of the joint.

5. A joint according to claims 2 in which the first and second surfaces are of substantially annular extent and are arranged in positions facing one another for mutual superimposition at the preselected maximum inclination between the first and second axes of the joint elements.

6. A joint according to claim 1 in which the shell element is made in at least two parts of predominantly hemispherical shape.

7. A joint according to claim 2 in which the body extends coaxially as an extension of the first portion and the first surface is a shoulder between the first spherical-sector-shaped portion and the body.

8. A joint according to claim 7 in which the first shoulder surface is at least partially a base of a spherical-sector-shaped portion forming the first portion.

9. A joint according to claim 1 in which the body and the corresponding spherical-sector-shaped portion of the first joint element are produced as a unitary part.

10. A joint according to claim 2 in which the blind axial cavity is formed coaxially in the second portion of the corresponding joint element, the second surface extending around the cavity so as to adjoin the spherical region of the second portion.

11. A joint according to claim 10 in which the blend axial cavity and the corresponding spherical-sector-shaped portion of the second joint element are produced as a unitary part.

12. A joint according to claim 1 in which the shell has openings in the region of the axes of rotation of the joint elements for the insertion of respective axial ends of the joint elements which are arranged for connection to the corresponding drive-transmission shafts, the openings being of an extent such as to permit relative inclination between the joint elements, up to the preselected maximum inclination.

13. A joint according to claim 2 in which the first and second surfaces are selected with profiles such that, at the maximum inclination between the shafts, they are in mutual contact, tangentially relative to one another, during the transmission of drive between the elements of the joint.

14. A joint according to claim 3 in which the first and second surfaces are of substantially annular extent and are arranged in positions facing one another for mutual superimposition at the preselected maximum inclination between the first and second axes of the joint elements.

15. A joint according to claim 4 in which the first and second surfaces are of substantially annular extent and are arranged in positions facing one another for mutual superimposition at the preselected maximum inclination between the first and second axes of the joint elements.

16. A joint according to claim 2 in which the shell element is made in at least two parts of predominantly hemispherical shape.

17. A joint according to claim 3 in which the shell element is made in at least two parts of predominantly hemispherical shape.

18. A joint according to claim 4 in which the shell element is made in at least two parts of predominantly hemispherical shape.

19. A joint according to claim 5 in which the shell element is made in at least two parts of predominantly hemispherical shape.

20. A joint according to claim 3 in which the body extends coaxially as an extension of the first portion and the first surface is a shoulder between the first spherical-sector-shaped portion and the body.

21. A joint according to claim 4 in which the body extends coaxially as an extension of the first portion and the first surface is a shoulder between the first spherical-sector-shaped portion and the body.

22. A joint according to claim 5 in which the body extends coaxially as an extension of the first portion and the first surface is a shoulder between the first spherical-sector-shaped portion and the body.

23. A joint according to claim 6 in which the body extends coaxially as an extension of the first portion and the first surface is a shoulder between the first spherical-sector-shaped portion and the body.

24. A joint according to claim 2 in which the body and the corresponding spherical-sector-shaped portion of the first joint element are produced as a unitary part.

25. A joint according to claim 3 in which the body and the corresponding spherical-sector-shaped portion of the first joint element are produced as a unitary part.

26. A joint according to claim 4 in which the body and the corresponding spherical-sector-shaped portion of the first joint element are produced as a unitary part.

27. A joint according to claim 5 in which the body and the corresponding spherical-sector-shaped portion of the first joint element are produced as a unitary part.

28. A joint according to claim 3 in which the blind axial cavity is formed coaxially in the second portion of the corresponding joint element, the second surface extending around the cavity so as to adjoin the spherical region of the second portion.

29. A joint according to claim 4 in which the blind axial cavity is formed coaxially in the second portion of the corresponding joint element, the second surface extending around the cavity so as to adjoin the spherical region of the second portion.

30. A joint according to claim 5 in which the blind axial cavity is formed coaxially in the second portion of the corresponding joint element, the second surface extending around the cavity so as to adjoin the spherical region of the second portion.

31. A joint according to claim 2 in which the shell has openings in the region of the axes of rotation of the joint elements for the insertion of respective axial ends of the joint elements which are arranged for connection to the corresponding drive-transmission shafts, the openings being of an extent such as to permit relative inclination between the joint elements, up to the preselected maximum inclination.

32. A joint according to claim 3 in which the shell has openings in the region of the axes of rotation of the joint elements for the insertion of respective axial ends of the joint elements which are arranged for connection to the corresponding drive-transmission shafts, the openings being of an extent such as to permit relative inclination between the joint elements, up to the preselected maximum inclination.

33. A joint according to claim 4 in which the shell has openings in the region of the axes of rotation of the joint elements for the insertion of respective axial ends of the joint elements which are arranged for connection to the corresponding drive-transmission shafts, the openings being of an extent such as to permit relative inclination between the joint elements, up to the preselected maximum inclination.

34. A joint according to claim 5 in which the shell has openings in the region of the axes of rotation of the joint elements for the insertion of respective axial ends of the joint elements which are arranged for connection to the corresponding drive-transmission shafts, the openings being of an extent such as to permit relative inclination between the joint elements, up to the preselected maximum inclination.
